(19) United States
(12) Patent Application Publication
(10) Pub. No.: US 2010/0231499 A1
(43) Pub. Date: Sep. 16, 2010

(54) METHOD FOR DRIVING LCD BACKLIGHT MODULES

(76) Inventors: Chun-Chieh Chiu, Taoyuan County (TW); Shih-Chieh Yen, Chiayi County (TW)

Correspondence Address: NORTH AMERICA INTELLECTUAL PROPERTY CORPORATION, P.O. BOX 506, MERRIFIELD, VA, 22116, US

(21) Appl. No.: 12/430,900

(22) Filed: Apr. 28, 2009

(30) Foreign Application Priority Data
Mar. 12, 2009 (TW) 098108023

(51) Int. Cl. G09G 3/36

(52) U.S. Cl. 345/102

(57) ABSTRACT

A method for driving LCD backlight modules provides a constant operational current during a first predetermined period for adjusting the brightness of a backlight from a first brightness to a second brightness. After the brightness of the backlight reaches the second brightness, the method provides an impulse-type operational current during a second predetermined period for improving motion blur.

### BACKGROUND OF THE INVENTION

1. Field of the Invention

The present invention is related to a method for driving an LCD backlight module, and more particularly, to a method for driving an LCD backlight module which reduces motion blur.

2. Description of the Prior Art

Liquid crystal display (LCD) devices, characterized in thin appearance, low power consumption and low radiation, have been widely used in electronic products, such as computer systems, mobile phones, or personal digital assistants (PDAs). By rotating liquid crystal molecules and thereby controlling light transmission, LCD devices can display gray scales of different brightness. Traditional cathode ray tube (CRT) devices are driven by impulse-type signals, while LCD devices are driven by hold-type signals. Since the rotation of liquid crystal molecules results in continuous variations in brightness, the LCD device has a slower response speed than the CRT device when presenting motion images. Therefore, motion blur is a common problem when the LCD device displays moving objects. Normally, black insertion technique which simulates the driving method of the CRT device is used for driving the LCD device in order to reducing motion blur and to improve display quality.

In traditional data black insertion technique, the backlight module of the LCD device adopts a full-lighting backlight and black frames are inserted by changing the amount of data transmission using a driving circuit. In other words, sub-frames having zero or lower gray scales are inserted periodically between subsequent frames. Since the backlight module is lit continuously and liquid crystal material has slow response, data black insertion technique can only slightly reduce motion blur, while causing other problems such as image flicker and insufficient brightness. Also, when data black insertion technique is applied to large-sized LCD devices, long signal transmission paths may result in electromagnetic interference (EMI) or signal attenuation.

In traditional blanking backlight black insertion technique, the backlight module of the LCD device adopts a full-blanking backlight. Without changing the amount of data transmission, black frames are inserted by turning on and turning off the backlight. Though capable of reducing motion blur, blanking backlight black insertion technique also causes other problems such as image flicker, ghost image and insufficient brightness.

In traditional scanning backlight black insertion technique, the backlight module of the LCD device adopts a partial-blanking backlight. Without changing the amount of data transmission, black frames are inserted by turning on and turning off a portion of the backlight. The way the backlight scans is synchronized with the amount of data transmission of the liquid crystal, which is lit by the corresponding portion of the backlight after reaching stable state. Scanning backlight black insertion technique can reduce motion blur and ghost image, but may still cause slight image flicker and insufficient brightness.

Reference is made to FIG. 1 for a diagram illustrating the operation of a prior art scanning backlight module. In FIG. 1, S1 represents the scan signal of the backlight module, D represents the duty cycle of the scan signal S1, and T represents the period of the scan signal S1. Signal IL represents the operational current of the backlight module, and signal IL represents the brightness of the backlight module. Tr is the brightness rising time, and Tf is the brightness falling time. The backlight module is turned on/off based on the scan signal S1, while the ratio between the on-time and off-time of the backlight module is determined by the duty cycle D. After being turned on by the scan signal S1, it takes Tr for the lamp of the backlight module to radiate with a stable brightness; after being turned off by the scan signal S1, it takes Tf for the lamp of the backlight module to reach complete darkness. Fluorescent lamps with slow response speed to light, such as hot cathode fluorescent lamps (HCFLs) and cold cathode fluorescent lamps (CCFLs), are commonly used as the backlight of LCD devices. For example, the light-activating time (for the relative brightness to increase from 10% to 90%) and the light-decaying time each take about 3 ms each. Since the lamp needs a long time to reach the stable state, motion blur cannot be reduced effectively.

### SUMMARY OF THE INVENTION

The present invention provides a method for driving a backlight comprising providing a constant first operational current during a first predetermined period for adjusting a brightness of the backlight from a first brightness to a second brightness; and providing an impulse-type second operational current during a second predetermined period after the brightness of the backlight reaches the second brightness.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the operation of a prior art scanning backlight module.

FIG. 2 is a timing diagram illustrating a method for driving a scanning backlight module according to a first embodiment of the present invention.

FIG. 3 is a timing diagram illustrating a method for driving a scanning backlight module according to a second embodiment of the present invention.

FIG. 4 is a timing diagram illustrating a method for driving a scanning backlight module according to a fourth embodiment of the present invention.

### DETAILED DESCRIPTION

Certain terms are used throughout the following description and claims to refer to particular components. As one skilled in the art will appreciate, manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”.

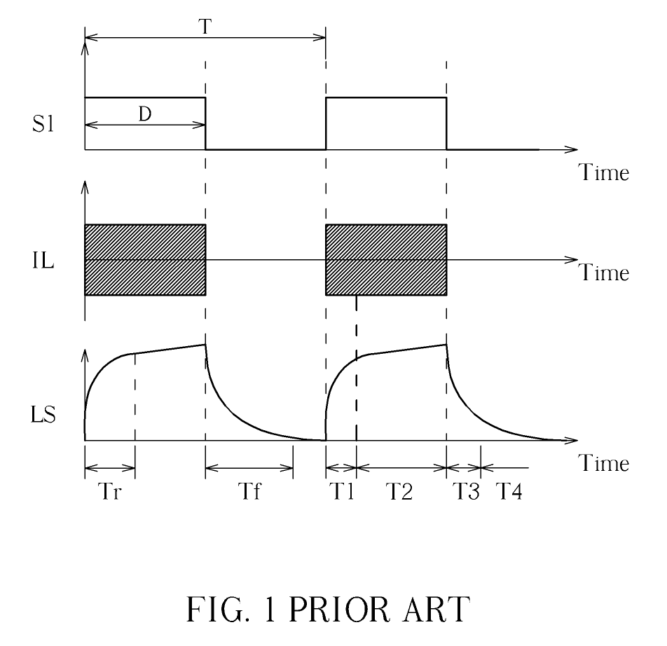

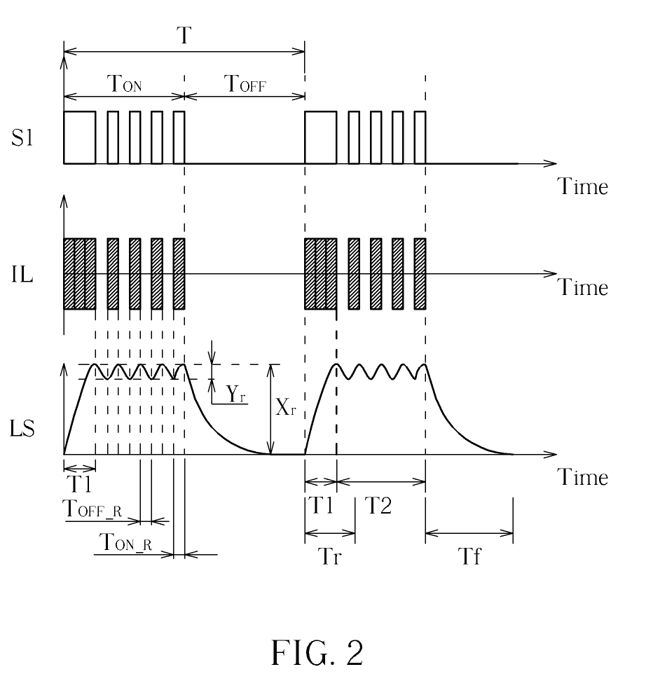

Compared to the scan signal S1 having a constant duty cycle used in the prior art, the present invention adjusts the scan signal based on the brightness characteristics of a scanning backlight module. After having been turned on for a period of time, the backlight module is then alternatively switched on and off at a predetermined frequency in the present invention. Reference is made to FIG. 2 for a timing diagram illustrating a method for driving a scanning backlight module according to a first embodiment of the present invention. In FIG. 2, S1 represents the scan signal of the backlight module, signal IL represents the operational current of the backlight module, and signal IL represents the brightness of the backlight module. Referring to the characteristic curves depicted in FIGS. 1 and 2, the period T of the scan signal S1 includes a turn-on period T_{ON} and a turn-off period T_{OFF}. In each turn-on period T_{ON}, the waveform of the scan signal LS includes a fast-responding period T1 and a slow-responding period T2. At the beginning of the turn-on period T_{ON}, the lamps of the backlight module operate in the fast-responding period T1 in which the brightness of the lamps rises rapidly due to faster response to light. After having been turned on for a while, the lamps of the backlight module enter the slow-responding period T2 in which the brightness of the lamps rises gradually due to slower response to light. During the slow-responding period T2, the lamps of the backlight module require a longer time to reach the stable state. The brightness rising time Tr is thus greatly lengthened, but only limited increase in light brightness can be gained during this period.

Therefore, during the turn-on period T_{ON} of the lamps, the first embodiment of the present invention drives the scanning backlight module using a scan signal S1 having a constant high voltage level in the fast-responding period T1, while using an impulse-type scan signal S1 in the slow-responding period T2. In the fast-responding period T1, the turn-on time of the scan signal S1 can also be represented by T1; in the slow-responding period T2, the turn-on time and the turn-off time of the scan signal S1 can respectively be represented by T_{ON}_{_{—}}_{R} and T_{OFF}_{_{—}}_{R}. As shown in FIG. 2, the lamps of the backlight module, which are turned on during the fast-responding period T1, can rapidly achieve a predetermined brightness with a brightness gain Xr. After entering the slow-responding period T2, the lamps of the backlight module are first turned off by the impulse-type scan signal S1. The brightness of the lamps decreases gradually with a brightness drop Yr within the period of T_{OFF}_{_{—}}_{R}. To prevent the lamp brightness from deviating of the predetermined brightness too much, the impulse-type scan signal S1 then turns on the lamps. The brightness of the lamps thus increases gradually and reaches the predetermined brightness after T_{ON}_{_{—}}_{R}.

In the first embodiment of the present invention, the turn-on time T_{ON}_{_{—}}_{R}, T1 and the turn-off time T_{OFF}_{_{—}}_{R} of the lamps can be determined by the characteristics and operating conditions of the lamps. For example, in order to shorten the brightness rising time to T1, the value of Xr required for achieving the predetermined brightness can be acquired based on the light response speed. Meanwhile, for the fluctuation in the waveform of the signal LS to be less than 1/10 (Yr/Xr<1/10), both the turn-on time T_{ON}_{_{—}}_{R} and the turn-off time T_{OFF}_{_{—}}_{R} must not exceed T1/10. Thus, each turn-off time T_{OFF}_{_{—}}_{R} in the impulse-type scan signal S1 can be set to T1/10 in the first embodiment of the present invention. Furthermore, if the nonlinear variation in particle decay of the lamp characteristics is taken into consideration, a characteristic parameter P can be introduced so that the turn-off time T_{OFF}_{_{—}}_{R} of the impulse-type scan signal S1 gradually decreases. For example, the first turn-off time after T1 can be set to T1/(10−4P/5), the second turn-of time after T1 can be set to T1/(10−3P/5), . . . , etc. In the first embodiment of the present invention, the scan signal S1 is adjusted according to the lamp characteristics: the scan signal S1 having a constant high voltage level is used for driving the scanning backlight module in the fast-responding period T1 in order to shorten the brightness rising time; the impulse-type scan signal S1 is used for driving the scanning backlight module in the slow-responding period T2 in order to maintain the predetermined brightness. Therefore, the present invention can largely improve display quality by reducing motion blur.

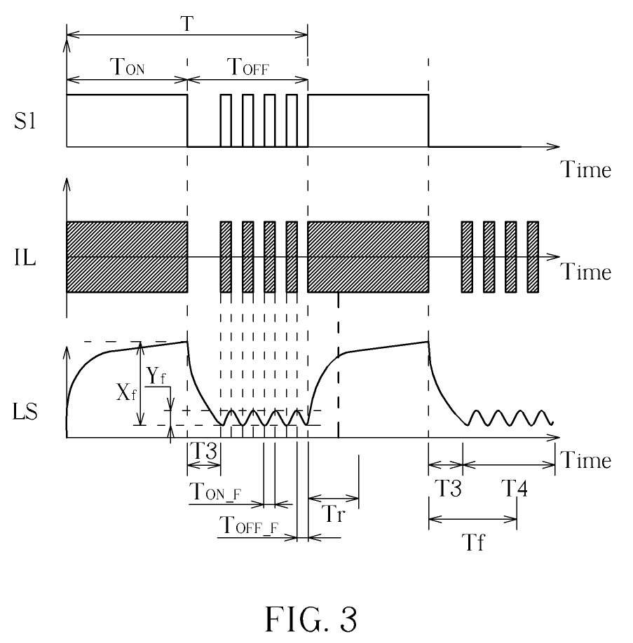

Reference is made to FIG. 3 for a timing diagram illustrating a method for driving a scanning backlight module according to a second embodiment of the present invention. In FIG. 3, S1 represents the scan signal of the backlight module, signal IL represents the operational current of the backlight module, and signal IL represents the brightness of the backlight module. Referring to the characteristic curves depicted in FIGS. 1 and 3, the period T of the scan signal S1 includes a turn-on period T_{ON} and a turn-off period T_{OFF}. In each turn-on period T_{ON}, the waveform of the scan signal LS includes a fast-responding period T3 and a slow-responding period T4. At the beginning of the turn-off period T_{OFF}, the lamps of the backlight module operate in the fast-responding period T3 in which the brightness of the lamps drops rapidly due to faster response to light. After having been turned off for a while, the lamps of the backlight module enter the slow-responding period T4 in which the brightness of the lamps decreases gradually due to slower response to light. During the slow-responding period T4, the brightness falling time Tf is greatly lengthened, but only limited decrease in light brightness can be achieved during this period.

Therefore, during the turn-on period T_{ON} of the lamps, the second embodiment of the present invention drives the scanning backlight module using a scan signal S1 having a constant high voltage level in the fast-responding period T3, while using an impulse-type scan signal S1 in the slow-responding period T4. In the fast-responding period T3, the turn-off time of the scan signal S1 can also be represented by T3; in the slow-responding period T4, the turn-on time and the turn-on time of the scan signal S1 can respectively be represented by T_{ON}_{_{—}}_{F} and T_{OFF}_{_{—}}_{F}. As shown in FIG. 3, the lamps of the backlight module, which are turned off during the fast-responding period T3, can rapidly achieve a predetermined brightness with a brightness drop Xf. After entering the slow-responding period T4, the lamps of the backlight module are first turned on by the impulse-type scan signal S1. The brightness of the lamps gradually increases from the predetermined brightness with a brightness gain Yf within the period of T_{ON}_{_{—}}_{R}. To prevent the lamp brightness from deviating of the predetermined brightness too much, the impulse-type scan signal S1 then turns off the lamps. The brightness of the lamps thus decreases gradually and reaches the predetermined brightness after T_{OFF}_{_{—}}_{F}.

In the second embodiment of the present invention, the turn-on time T_{ON}_{_{—}}_{F}, T3 and the turn-off time T_{OFF}_{_{—}}_{F} of the lamps can be determined by the characteristics and operating conditions of the lamps. For example, in order to shorten the brightness falling time to T3, the value of Xf required for achieving the predetermined brightness can be acquired based on the light response speed. Meanwhile, for the fluctuation in the waveform of the signal LS to be less than 1/10 (Yf/Xf<1/10), both the turn-on time T_{ON}_{_{—}}_{F} and the turn-off time T_{OFF}_{_{—}}_{F} must not exceed T3/10. Thus, each turn-on time T_{ON}_{_{—}}_{F} in the impulse-type scan signal S1 can be set to T3/10 in the second embodiment of the present invention. Furthermore, if the nonlinear variation in particle accumulation of the lamp characteristics is taken into consideration, a characteristic parameter P can be introduced so that the turn-on time T_{ON}_{_{—}}_{F} of the impulse-type scan signal S1 gradually decreases. For example, the first turn-on time after T3 can be set to T1/(10−4P/5), the second turn-on time after T3 can be set to T1/(10−3P/5), . . . , etc. In the second embodiment of the present invention, the scan signal S1 is adjusted according to the lamp characteristics: the scan signal S1 having a constant low voltage level is used for driving the scanning backlight module in the fast-responding period T3 in order to shorten the brightness falling time; the impulse-type scan signal S1 is used for driving the scanning backlight module in the slow-responding period T4 in order to maintain the predetermined brightness. Therefore, the present invention can largely improve display quality by reducing motion blur.

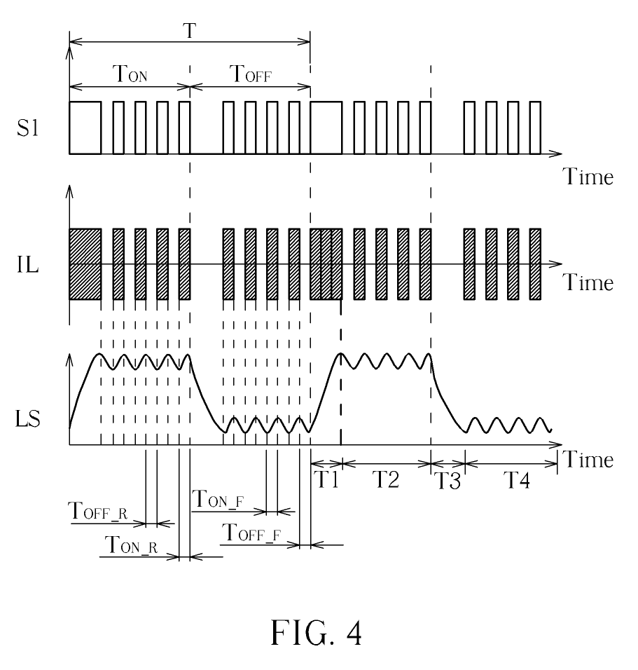

Reference is made to FIG. 4 for a timing diagram illustrating a method for driving a scanning backlight module according to a third embodiment of the present invention. In FIG. 4, S1 represents the scan signal of the backlight module, signal IL represents the operational current of the backlight module, and signal IL represents the brightness of the backlight module. The third embodiment of the present invention combines the methods illustrated in the first and second embodiments of the present invention. During the turn-on period T_{ON} of the lamps, the third embodiment of the present invention drives the scanning backlight module using the scan signal S1 having a constant high voltage level in the fast-responding period T1, while using the impulse-type scan signal S1 in the slow-responding period T2. During the turn-off period T_{OFF} of the lamps, the third embodiment of the present invention drives the scanning backlight module using the scan signal S1 having a constant low voltage level in the fast-responding period T3, while using the impulse-type scan signal S1 in the slow-responding period T4. The operation and the characteristic curve LS of the third embodiment of the present are similar to those of the first and second embodiment. Meanwhile, the turn-on time T_{ON}_{_{—}}_{R}, T_{ON}_{_{—}}_{F}, T1 and the turn-off time T_{OFF}_{_{—}}_{R}, T_{OFF}_{_{—}}_{F}, T3 of the lamps can be determined by the characteristics and operating conditions of the lamps, thereby greatly reducing motion blur.

The present invention adjusts the scan signal based on the brightness characteristics of the scanning backlight module. After having been turned on for a period of time, the backlight module is then alternatively switched on and off at a predetermined frequency in the present invention. The brightness rising and falling time can thus be shortened, thereby greatly reducing motion blur.

Those skilled in the art will readily observe that numerous modifications and alterations of the device and method may be made while retaining the teachings of the invention.

What is claimed is:

1. A method for driving a backlight comprising:
providing a constant first operational current during a first predetermined period for adjusting a brightness of the backlight from a first brightness to a second brightness; and
providing an impulse-type second operational current during a second predetermined period after the brightness of the backlight reaches the second brightness.

2. The method of claim 1 further comprising:
setting the first predetermined period based on a period of the backlight reaching the second brightness from the first brightness.

3. The method of claim 1 further comprising:
setting a turn-on time and a turn-off time of the second operational current in the second predetermined period based on the second brightness and a first brightness variation parameter.

4. The method of claim 3 wherein the first brightness variation parameter corresponds to a ratio between the first and second brightness.

5. The method of claim 1 further comprising:
setting a turn-on time and a turn-off time of the second operational current in the second predetermined period based on a characteristic parameter of the backlight.

6. The method of claim 5 wherein the characteristic parameter corresponds to a particle decay characteristic of the backlight.

7. The method of claim 1 further comprising:
providing a constant third operational current during a third predetermined period for adjusting the brightness of the backlight from the second brightness to the first brightness; and
providing an impulse-type fourth operational current during a fourth predetermined period after the brightness of the backlight reaches the first brightness.

8. The method of claim 7 further comprising:
setting the third predetermined period based on a period of the backlight reaching the first brightness from the second brightness.

9. The method of claim 7 further comprising:
setting a turn-on time and a turn-off time of the fourth operational current in the fourth predetermined period based on the first brightness and a second brightness variation parameter.

10. The method of claim 9 wherein the second brightness variation parameter corresponds to a ratio between the first and second brightness.

11. The method of claim 7 further comprising:
setting a turn-on time and a turn-off time of the fourth operational current in the fourth predetermined period based on a characteristic parameter of the backlight.

12. The method of claim 11 wherein the characteristic parameter corresponds to a particle decay characteristic of the backlight.

13. The method of claim 11 wherein the characteristic parameter corresponds to a particle accumulation characteristic of the backlight.

14. The method of claim 7 further comprising:
providing a scan signal for controlling the third and fourth operational currents.

15. The method of claim 1 further comprising:
providing a scan signal for controlling the first and second operational currents.

16. The method of claim 1 wherein the backlight includes a hot cathode fluorescent lamp (HCFL) or a cold cathode fluorescent lamp (CCFL).
